(19) United States
(12) Patent Application Publication
(10) Pub. No.: US 2021/0396203 A1
(43) Pub. Date: Dec. 23, 2021

(54) UNDERGROUND ENERGY PRODUCTION AND STORAGE SYSTEM

(71) Applicant: Hans Gude Gudesen, Gamle Fredrikstad (NO)

(72) Inventor: Hans Gude Gudesen, Gamle Fredrikstad (NO)

(21) Appl. No.: 17/288,919

(22) PCT Filed: Nov. 26, 2019
(86) PCT No.: PCT/NO2019/050259

§ 371 Date: Apr. 27, 2021

(30) Foreign Application Priority Data
Nov. 27, 2018 (NO) 20181523

(51) Int. Cl. F03B 13/06; F03B 13/08; F03B 3/10

(52) U.S. Cl. CPC F03B 13/06; F05B 2260/422; F03B 3/10; F03B 13/08

(57) ABSTRACT

A hydropower system for generating and storing energy is disclosed. The system comprises an upper (1) and a lower (2) level reservoir, and an electromechanical system (12) arranged in the lower level reservoir and in hydraulic connection with the upper level reservoir. A related method generating and storing energy is also disclosed.

### FIELD OF THE INVENTION

The present invention relates to a system and a method for generating and storing hydroelectric energy underground.

### BACKGROUND OF THE INVENTION

The concept of underground pumped hydropower is known in the Prior Art. It is conceptually similar to aboveground pumped hydropower where energy is stored by pumping water from a low-lying recipient to a water reservoir at a higher elevation. When energy is needed, the water is returned to a turbine/generator combination at a lower level and dropped into the lower recipient. In underground pumped hydropower plants, the upper level reservoir does not need to be located at high level aboveground, since water is delivered to the turbine at a level below the ground. A requirement for this is that the spent water from the turbine can be accommodated in an underground recipient of sufficient capacity.

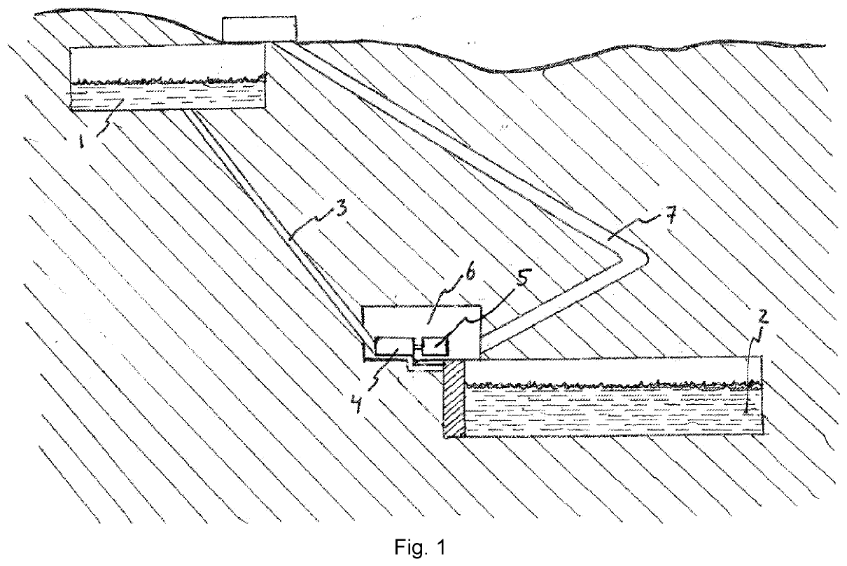

Underground pumped hydropower schemes have until now had only a negligible impact on the total global energy economy. The main reasons for this are ultimately economic, linked to the cost of establishing the underground infrastructure. FIG. 1 shows a generic prior art underground pumped hydroelectric facility comprising an upper (1) and a lower (2) water reservoir. In the energy production mode, water is passed through a penstock shaft (3) from the upper to the lower reservoir and flows through a turbine (4) which drives an electrical generator (5), the spent water being collected in the lower reservoir (2). In the energy storage mode, water is pumped from the lower to the upper reservoir, either by running the turbine in reverse or by means of a separate pump. The turbine and generator as well as other equipment are located in a gallery (6) above the lower reservoir (2), and the gallery is connected to the surface via adits (7) and access, ventilation and cable shafts (not shown). The volumetric capacity of the lower reservoir is a critical parameter for the energy storage capacity of the facility. In large utility-connected facilities, the required capacity shall typically be in the range 100,000[m³] to 1,000,000[m³]. The creation of deep underground caverns of such size represent enormous technical and logistical challenges, and the associated costs have so far deterred attempts at excavation of large scale facilities from scratch. Instead, there have been several studies where existing natural or man made cavities in the underground have been analyzed with respect to being modified or expanded for use as water reservoirs in underground pumped hydropower facilities. Thus, in many locations in the world there are abandoned mines with associated shafts and adits, often encompassing large volumes and being at relevant depths below the surface. However, such locations may not provide access to the required water resources and impose geographical constraints which are often incompatible with other factors such as proximity to the (typically intermittent) power sources and the consumers. Furthermore, closer scrutiny shows that underground pumped hydroelectric facilities impose particular structural and other requirements which make many candidate underground mining networks unsuitable. Yet further, existing underground mining access systems of adits and shafts are often poorly suited for transporting large units such as turbines, generators and pumps to their intended locations deep underground, and it shall in many cases be necessary to transport the units in smaller parts, followed by re-assembly in situ.

A review and assessment of the opportunities and problems associated with using existing mining infrastructure is given in:
R. Madlener and J. M. Specht: “An Exploratory Economic analysis of Underground Pumped-Storage Hydro Power Plants in Abandoned Coal Mines”, FCN Working Paper No. 2/2013, February 2013. (http.//www.fcn.eonenerc.rwth-aachen.de/global/show_document.asp?id=aaaaaaaaaagwyg).

Thus, there exists a need for new concepts and technical solutions that can make underground pumped hydropower systems technically and economically viable and store or deliver electrical power on demand, where the energy may in whole or in part be derived from intermittent power sources such as wind and solar.

### OBJECTS OF THE PRESENT INVENTION

Accordingly, it is a major objective of the present invention to introduce novel concepts and techniques for underground pumped hydroelectric energy storage systems with the following characteristics:
The infrastructure costs shall be within commercially viable limits.
Site selection for the facilities shall not be dependent upon any prior underground infrastructure.
The environmental impact shall be negligible.
Facilities and equipment shall be easily accessible for service and repair.
Decommissioning shall be simple and cheap.

### Means for Solving the Problems

The objective is achieved according to the invention by a system and a method according to independent claims.

A number of non-exhaustive embodiments, variant or alternatives of the invention are defined by the dependent claims.

### SUMMARY OF THE INVENTION

A first aspect of the invention is a hydropower system for generating and storing energy, where the system comprises:
an upper level reservoir with an upper level water surface at an upper altitude,
a lower level reservoir with a lower level water surface at a lower altitude,
a penstock arranged for providing hydraulic connection between the upper level reservoir and at least one electromechanical system comprising a turbine and a generator for generating energy from the head of water below the upper level water surface, and providing a pumping function for storing energy by pumping water up from the lower level reservoir. The lower level reservoir comprises a first vertical shaft in the ground with a horizontal cross section throughout its length that allows lowering of the at least one electromechanical system through the vertical shaft.

Optionally, at least the turbine of the at least one electromechanical system is arranged in the lower level reservoir.

Optionally, the upper level reservoir is a natural body of water where the natural body of water can be the sea or bodies of water connected to it.

Optionally, the vertical shaft forms an opening at surface of the ground.

Optionally, at least the turbine is arranged at a lower level than the water surface of the lower level reservoir.

The vertical shaft preferably has a mainly uniform cross section, and more preferably essentially a cylindrical shape. Optionally, area of the cross section is at least 10 m².

Optionally, the lower level reservoir further comprises void and pore volumes in the ground surrounding the vertical shaft and where the void and pore volumes are in hydraulic connection with the vertical shaft. The void and pore volumes in the ground can be of natural origin, or the void and pore volumes in the ground can be at least partly man-made.

Optionally, the void and pore volumes in the ground and/or their hydraulic connection with the vertical shaft are created or enhanced by one or more of the following techniques: mechanical drilling, hydraulic fracturing, horizontal, vertical or radial jet drilling, explosion, plasma jet, water jet.

Optionally, the lower level reservoir comprises one or more vertical satellite shafts in hydraulic connection with the first vertical shaft via drilled channels and/or natural permeability in the ground between the vertical shaft and the satellite shafts.

Optionally, the lower level reservoir includes void and pore volumes in the ground surrounding the satellite shafts.

Optionally, the penstock comprises a tube section located in the first vertical shaft.

Optionally, the penstock comprises a vertical penstock shaft in the ground parallel to the first vertical shaft and in hydraulic connection with the first vertical shaft, arranged for providing hydraulic connection between the upper level reservoir and the electromechanical system.

Optionally, the pumping function is provided by the turbine operated in reverse. Optionally, the electromechanical system comprises a separate pump providing the pumping function.

A further aspect of the invention is a method for generating and storing energy using a hydropower system as described above.

A still further aspect of the inventions is a method for generating and storing energy, the method comprising the following steps:

i) in an energy production mode:
leading water from an upper level reservoir with an upper level water surface at an upper altitude through a penstock to an electromechanical system arranged in a vertical shaft in ground with an opening at surface of the ground, the vertical shaft and any hydraulically communicating voids in the ground comprising a lower level reservoir; and
generating energy by the electromechanical system from the head of water below the upper level water surface; and

ii) in an energy storage mode:
storing energy by pumping water up from the lower level reservoir through the penstock by means of the electromechanical system.

### DESCRIPTION OF THE DIAGRAMS

The above and further features of the invention are set forth with particularity in the appended claims and together with advantages thereof will become clearer from consideration of the following detailed description of an [exemplary] embodiment of the invention given with reference to the accompanying drawings.

Embodiments of the present invention will now be described, by way of example only, with reference to the following diagrams wherein:

FIG. 1 shows a generic underground pumped hydropower facility according to prior art.

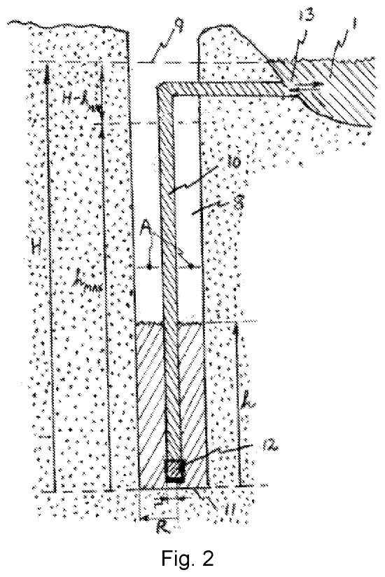

FIG. 2 discloses a version of the underground pumped hydropower facility according to the present invention.

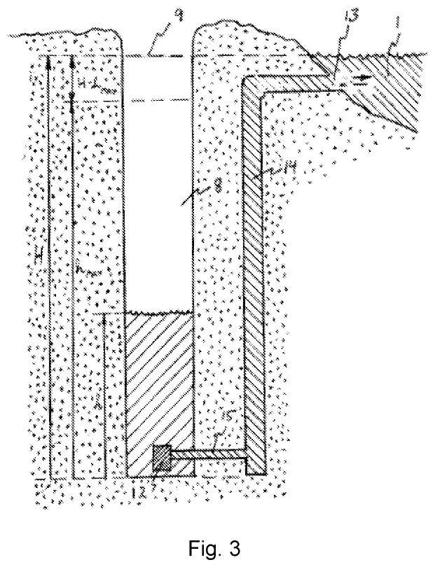

FIG. 3 discloses an embodiment of the present invention with a separate penstock shaft for transporting water to and from the turbine or pump.

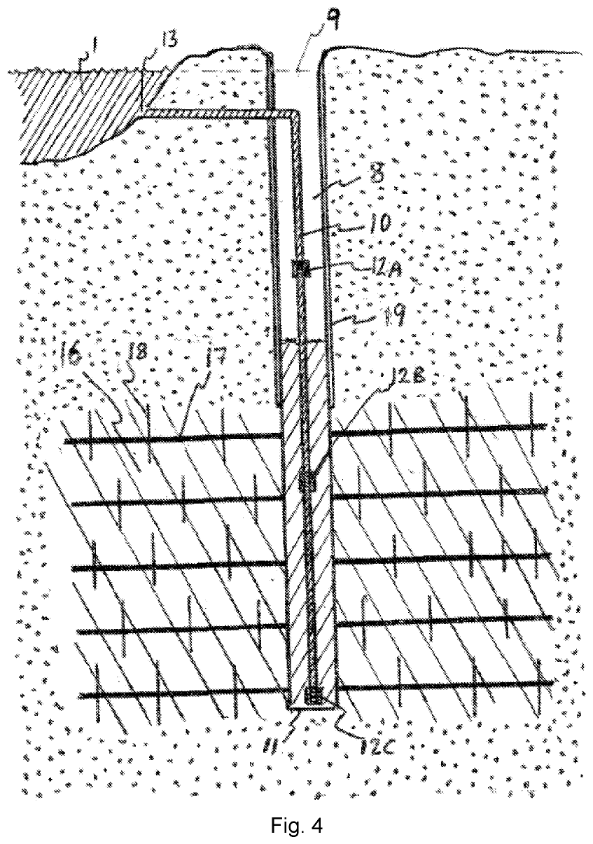

FIG. 4 discloses an embodiment of the present invention where void volumes in the surrounding rock contribute energy storage space and where the total head of water is handled by three electromechanical systems.

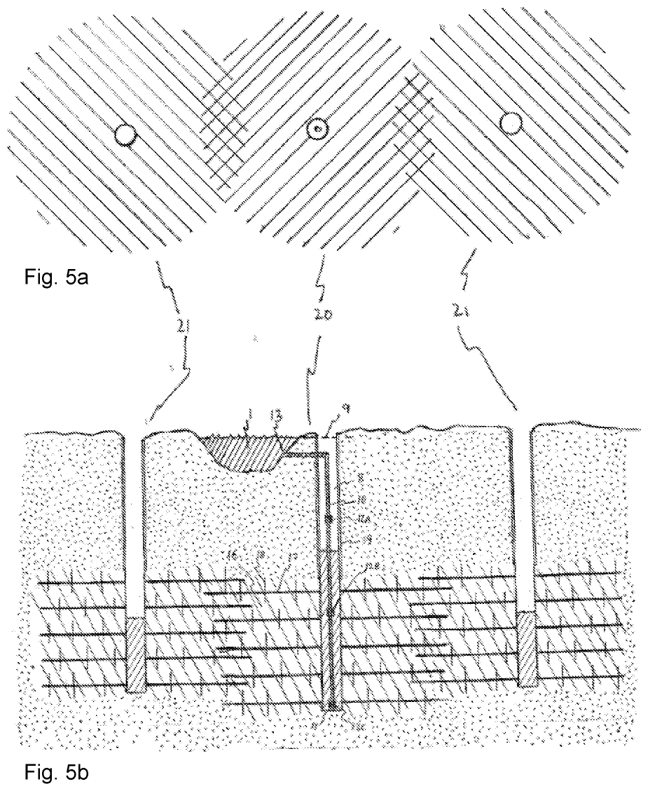

FIG. 5a and FIG. 5B disclose an embodiment of the present invention where two satellite shafts enhance the performance of the facility.

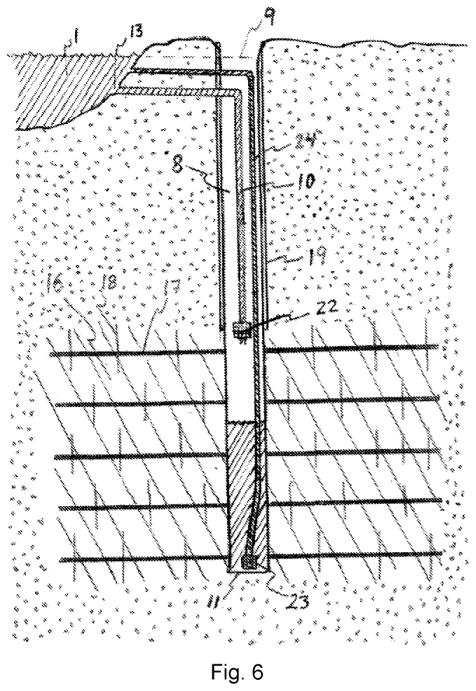

FIG. 6 discloses an embodiment of the present invention where the turbine and generator are located in dry surroundings.

### LIST OF REFERENCE NUMBERS IN THE FIGURES

The following reference numbers and signs refer to the drawings:

### NUMBER DESIGNATION

1 Upper reservoir

2 Lower reservoir

3 Penstock shaft (prior art)

4 Turbine

5 Electrical generator

6 Gallery

7 Adit

8 Vertical shaft

9 Surface of upper reservoir

10 Penstock tube

11 Bottom of shaft

12 Electromechanical system.

12A, B, C Electromechanical system.

13 Top of penstock tube or -shaft

14 Penstock shaft

15 Tube

16 Interstitial volumes

17 Channels

18 Channels

19 Casing

20 Central facility

21 Satellite to central facility

22 Turbine/generator combination

23 Pump

24 Water evacuation tube from pump

### DESCRIPTION OF PREFERRED EMBODIMENTS OF THE INVENTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The following description of a preferred embodiment of the invention is exemplary without limiting the invention or the application.

The present invention relies on a novel architecture where the system of underground cavities is created using optimized, effective excavation and construction techniques, where the water storage capacity of the system cavities is exploited to an extraordinary degree, where the installation, maintenance and removal of major system components can be implemented in a simple manner, and where the total energy storage capacity of the system can be extended in stages following the initial construction of the system.

In basic terms, the above is achieved by creating a straight vertical shaft extending from the surface and down to a predetermined depth, the volume of the shaft representing the storage volume for the lower water reservoir in the system. The upper reservoir is a large body of water, preferably the sea, in communication with a water intake at the top of a penstock tube inserted into the shaft and feeding an electromechanical system including a submerged turbine/generator combination positioned at the bottom of the shaft. In the energy production mode, water is taken from the upper water reservoir via the penstock and flows through the turbine. The latter shall be of the reaction type, expelling spent water into the surrounding shaft volume against a head which increases as the water level rises in the shaft. In the energy storage mode, the turbine acts as a pump, drawing water from the bottom of the shaft and pushing it up through the penstock tube and into the upper water reservoir.

Some salient features of this architecture:
It opens up for employing a set of standardized procedures and optimized equipment in the excavation phase. This includes the use of highly automated robotic equipment, with associated benefits regarding overall costs and safety aspects. The vertical straight shaft may in principle have any cross sectional shape, with preferred embodiments being circular, and is without extended overhangs that would require bracing against vertical forces within the rock. The cross sectional area shall provide adequate space for machinery and operations during excavation of the shaft and for installation and operation of turbines, generators etc., which shall typically imply a minimum shaft diameter of 5-10 m. This would also be adequate during possible extensions of water storage volume by horizontal drilling into void volumes in the surrounding rock (cf. below).
Heavy equipment, in particular the turbine and generator, can be inserted by lowering straight down into the shaft. Likewise, service, repair and decommissioning will be facilitated by easy vertical access via hoists.
The architecture allows simple post construction scaling of storage capacity or power by one or more of the following: By exchange of turbine, by increasing the depth of the shaft, by creating access to interstitial volumes surrounding the shaft (cf. below), and by establishing parallel shafts in a production cluster.

The basic principles shall now be described in detail by reference to FIG. 2, which shows one embodiment of the present invention:

The upper reservoir (1) is a large natural body of water such as the sea. A vertical shaft (8) of diameter 2R extending from the surface to a depth H constitutes the lower reservoir. A penstock tube (10) of diameter 2r inside the shaft (8) extends from the bottom (11) of the shaft to the upper reservoir (1) where the water surface level (9) defines a reference for the hydraulic head of the system. An electromechanical system (12) which can function both as a turbine/generator combination and a pump is located at the lower end of the tube, controlling the flow of water between the tube and the shaft:

In the energy storage mode, water is emptied from the shaft by supplying electrical power to the electromechanical system (12) which acts as a pump and forces water up and out of the penstock tube (10) at the point (13). In the energy production mode, water is inserted into the penstock tube (10) at the point (13) and is passed through the electromechanical system (12) which acts as a turbine/generator and delivers electrical power. The water exits at the bottom (11) of the shaft, filling it up from below. As can be seen from FIG. 2, the net head of water driving the turbine at any given time is (H−h), where h is the height of the water column in the shaft. As h gradually increases, an opposing hydrostatic pressure to that of the column in the penstock tube (10) is created, and ultimately the net head of water (H−h) becomes negligible as h approaches H in magnitude. In practical systems, power generation shall be terminated before this point, corresponding to a maximum height h_{Max} of the water column in the shaft as indicated by h_{Max} in FIG. 2.

In the energy storage mode, an amount Q of energy is required to lift all the water out of the shaft (8) when filled to level h_{Max}, i.e. to bring h from h=h_{Max} to h=0, corresponding to lifting the center of gravity of the column of water in the shaft to the level of the upper reservoir surface (9):

Q=ρ A g (H−h_{Max}/2) h_{Max} Eq. (1)

Here, the cross sectional area of the shaft between the penstock tube (10) and the shaft walls is A, ρ is the density of the water and g is the acceleration of gravity.

In the energy production mode, the power P delivered by a water flow dq/dt through the electromechanical system (12) is:

P=ρ g (H−h) dq/dt Eq. (2)

Here, it has been assumed that friction losses, etc can be ignored, i.e. an overall efficiency η=1.

For concreteness, some numerical examples shall now be given, based on the equations above:

Stored Energy:

Assuming R=5 [m], r=0.6 [m], the cross sectional area A of the shaft between the penstock tube (10) and the shaft walls is:

A=π (R²−r²)=77.4 [m²] Eq. (3)

Inserting further: ρ=1000 [kg m⁻³], g=9.81 [m s⁻²], H=700 [m], h_{Max}=690 [m] into Eq. (1), one obtains: Q=51.7 [MWh],

Power:

Assuming a flow dq/dt=1 [m³ s⁻¹], insertion into Eq. (2) yields:
P=6.9 [MW] at h=0;
P=98.1 [kW] at h=h_{Max}.

The reduction in power as water fills up the shaft may be compensated for by adjusting the flow rate dq/dt. Thus, if the turbine/generator allows it, a constant power yield of 1 [MW] may be achieved by increasing the flow rate from 0.15 [m³ s⁻¹] at h=0 to 10.2 [m³ s⁻¹] at h=h_{Max}.

Scaling:

As can be seen from Eq. (1), the storage capacity of the system shown in FIG. 2 shall scale as the area A, i.e. as the square of the linear dimensions of the shaft cross section. Making the simplifying assumption that h_{Max}=H, i.e. that there is no “dead volume” at the top of the shaft, Eq. (1) becomes:

Q=ρ A g H²/2 Eq. (4)

Thus, the stored energy shall essentially scale as the square of the depth of the shaft as well.

As an example of simple scaling, assuming a shaft cross section A=120 [m²] and a depth H=1500 [m], the stored energy becomes: Q=367 [MWh].

FIG. 3 shows a variant of the scheme illustrated in FIG. 2, where the penstock tube (10) has been supplanted by a penstock shaft (14) which is parallel to the shaft (8) and communicates via a tube (15) with the electromechanical system (12). The latter is positioned at the bottom of the shaft (8) in FIG. 3, but may alternatively be located at the bottom of the penstock shaft (14) or in the tube (15). In contrast to the scheme shown in FIG. 2, the one in FIG. 3 does not involve a penstock tube which is exposed to high and varying outside vs. inside pressure differentials linked to the head of water h at any given time. Also, removing the penstock tube (10) frees up volume in the shaft (8) and adds to the energy storage capacity of the system.

The basic scheme shown in FIG. 2 can be extended as shown in FIG. 4 to provide greatly increased storage capacities. In FIG. 4, the lower part of the shaft (8) has been hydraulically connected with interstitial volumes in the ground that extend outwards from the shaft, in the region indicated by the cross hatching (16) in FIG. 4. These volumes may be naturally occurring or man made voids in the form of cracks, cavities and pores, and can be accessed as shown in FIG. 4, where channels (17) have been drilled radially from the shaft (8), with smaller channels (18) branching off in transverse directions. In the embodiment shown in FIG. 4, the walls of the shaft (8) are supplied with a casing (19) in the upper part to avoid exchange of water with aquifers.

In FIG. 4, the total head of water in the penstock tube (10) has been divided into three parts, serviced by a sequence of three separate electromechanical systems (12A), (12B) and (12C) acting in concert. This arrangement reduces the pressure differential between the in/out water flows that must be handled by each turbine or pump in systems where the total head of water is high: In the energy production mode, the water first passes through the electromechanical system (12A) which extracts power and reduces the pressure before releasing water into the penstock tube below. Here, hydrostatic pressure then builds as water moves down the penstock tube to the next stage electromechanical system (12B) where more power is extracted, accompanied by a drop in pressure as water enters the lowest penstock tube stage and passes through the electromechanical system (12C) before debouching into the shaft (8). As described above in connection with FIG. 2, the rising water level in the shaft (8) causes the net head (H−h) driving the turbine in the electromechanical system (12) to be reduced. Analogously, in the segmented system shown in FIG. 4, the net head of water driving the lowest electromechanical system (12C) is reduced as the water level in the shaft (8) approaches the level of electromechanical system (12B). At this point, the electromechanical system (12C) no longer contributes to the energy production, and is put in an idling mode, i.e. by removing the generator electrical load. Alternatively, a port at the tailrace of electromechanical system (12B) is activated to release water into the shaft (8) at electromechanical system (12B), thus bypassing electromechanical system (12C). As the water level in the shaft rises further, the head of water driving the electromechanical system (12B) is reduced, ultimately causing it to be brought into idling mode also. In the energy storage mode, the three electromechanical systems (12A), (12B), (12C) act as a sequence of pumps in the same penstock tube where each performs roughly one third of the total lifting work.

The scheme illustrated in FIG. 4 relies upon the existence of rock formations in the region (16) surrounding the shaft that have porosity as well permeability. Both depend on the type of rock and may vary widely. Regarding porosity, naturally occurring void volumes relative to total volumes are typically as follows: In basalt, vesicles and fractures occupy up to 30-40%, in limestone, solution cavities occupy up to 5-25%, in sandstone spaces between grains occupy up to 10-40%, in granite, natural fractures typically occupy less than 1%. Permeability depends on the degree of connected porosity in the network of voids and may likewise vary between wide limits. As is well known in the oil and gas industry, it is possible to modify the porosity and permeability in rocks to a large degree by hydraulic fracturing and by horizontal and radial jet drilling, and similar technologies may be relevant in the present case. Thus the horizontal channels (17) and branching channels (18) shown in FIG. 4 may have bore diameters of the order of 10 cm. or less, extending several hundreds of meters and deviating at sharp angles from each other.

A very simple estimate of the potential impact of interstitial void volumes on the storage capacity can be made as follows: If the hydraulically connected void-containing volume shown cross hatched in FIG. 4 has a total volume V and is characterized by an average void fraction φ, the aggregate void volume is:

V_{Void}=φ V Eq. (5)

Assuming that this volume is available as a water storage reservoir during energy storage and energy production and can be characterized by an average depth H_{Void} below the surface, the maximum stored energy Q_{Void} in the void space is:

Q_{Void}=ρ g φ V H_{Void} Eq. (6)

Inserting some relevant numbers: ρ=1000 [kg m⁻³], g=9.81 [m s⁻²], φ=0.015, V=1 [km³], H_{Void}=1500 [m], into Eq. (6), one obtains: Q=61.4 [GWh].

FIGS. 5A, B illustrate how the concept of interstitial volume storage space can be extended: FIG. 5A shows a top view and FIG. 5B a side view of a central facility (20) similar to that shown in FIG. 4 surrounded by 2 satellites (21) that are in hydraulic communication with the central facility via drilled channels and interstitial volumes. The satellite shafts and their associated interstitial volumes provide enhanced space for water storage and pressure relief for water transport from the central shaft into the surrounding system of void space. In a simpler version without interstitial pore and crack volumes, the satellite shafts are directly connected with the central facility via drilled channels, and the total water storage volume of the coupled hydraulic system is the sum of the shaft and channel spaces.

FIG. 6 shows an embodiment of the present invention where a part of the electromechanical system comprising the turbine/generator combination (22) is located above the maximum level of water in the vertical shaft (8) while the pump (23) is located at the bottom of the vertical shaft (11). This allows the turbine/generator combination (22) to be operated in dry surroundings, but at a cost of sacrificing some of the energy storage capacity due to the smaller average head of water driving the turbine. As shown in FIG. 6, the pump (23) is connected to an evacuation tube (24) debouching into the upper reservoir (1). In the example shown in FIG. 6, the major part of the water storage takes place in the volume (16) below the turbine/generator combination (22), and the configuration shown shall lead to a relatively small loss of energy storage capacity.

Water leakage into our out of the facility from the surrounding rock shall clearly depend on the local geological conditions. One notes that loss of water from the facility through leakage shall effectively correspond to storing additional energy in the facility. In the reverse case where water intrudes from the surrounding rock formations, some stored energy is lost. However, such water intrusion shall in many cases occur at a low rate with small impact on the overall performance of the storage facility.

1. Hydropower system for generating and storing energy, wherein the system comprises:
an upper level reservoir with an upper level water surface at an upper altitude,
a lower level reservoir with a lower level water surface at a lower altitude,
a penstock arranged for providing hydraulic connection between the upper level reservoir and at least one electromechanical system comprising a turbine and a generator for generating energy from the head of water below the upper level water surface, and providing a pumping function for storing energy by pumping water up from the lower level reservoir,
wherein
the lower level reservoir comprises a first vertical shaft in the ground with a horizontal cross section throughout its length that allows lowering of the at least one electromechanical system through the vertical shaft.

2. Hydropower system according to claim 1, wherein at least the turbine of the at least one electromechanical system is arranged in the lower level reservoir.

3. Hydropower system according to claim 1, wherein the upper level reservoir is a natural body of water.

4. Hydropower system according to claim 3, wherein the natural body of water is the sea or bodies of water connected to it.

5. Hydropower system according to claim 1, wherein the vertical shaft forms an opening at surface of the ground.

6. Hydropower system according to claim 1, wherein at least the turbine is arranged at a lower level than the water surface of the lower level reservoir.

7. Hydropower system according to claim 1, wherein the vertical shaft preferably has a mainly uniform cross section, and more preferably essentially a cylindrical shape.

8. Hydropower system according to claim 1, wherein area of the cross section is at least 10 m².

9. Hydropower system according to claim 1, wherein the lower level reservoir further comprises void and pore volumes in the ground surrounding the vertical shaft and where the void and pore volumes are in hydraulic connection with the vertical shaft.

10. Hydropower system according to claim 9, wherein the void and pore volumes in the ground are of natural origin.

11. Hydropower system according to claim 9, wherein the void and pore volumes in the ground are at least partly man-made.

12. Hydropower system according to claim 11, wherein the void and pore volumes in the ground and/or their hydraulic connection with the vertical shaft are created or enhanced by one or more of the following techniques: mechanical drilling, hydraulic fracturing, horizontal, vertical or radial jet drilling, explosion, plasma jet, water jet.

13. Hydropower system according to claim 1, wherein the lower level reservoir comprises one or more vertical satellite shafts in hydraulic connection with the first vertical shaft via drilled channels and/or natural permeability in the ground between the vertical shaft and the satellite shafts.

14. Hydropower system according to claim 9, wherein the lower level reservoir includes void and pore volumes in the ground surrounding the satellite shafts.

15. Hydropower system according to claim 1, wherein the penstock comprises a tube section located in the first vertical shaft.

16. Hydropower system according to claim 1, wherein the penstock comprises a vertical penstock shaft in the ground parallel to the first vertical shaft and in hydraulic connection with the first vertical shaft, arranged for providing hydraulic connection between the upper level reservoir and the electromechanical system.

17. Hydropower system according to claim 1, wherein the pumping function is provided by the turbine operated in reverse.

18. Hydropower system according to claim 1, wherein the electromechanical system comprises a separate pump providing the pumping function.

19. Method for generating and storing energy using a hydropower system according to claim 1.

20. Method for generating and storing energy, the method comprising the following steps:
i) in an energy production mode:
leading water from an upper level reservoir with an upper level water surface at an upper altitude through a penstock to an electromechanical system arranged in a vertical shaft in ground with an opening at surface of the ground, the vertical shaft and any hydraulically communicating voids in the ground comprising a lower level reservoir; and
generating energy by the electromechanical system from the head of water below the upper level water surface; and
ii) in an energy storage mode:
storing energy by pumping water up from the lower level reservoir through the penstock by means of the electromechanical system.
